(19) United States
(12) Patent Application Publication
(10) Pub. No.: US 2023/0271729 A1
(43) Pub. Date: Aug. 31, 2023

(54) LIQUID-DRIVEN PROPULSION DEVICES

(71) Applicant: Taiwan Happy Energy Co., Ltd., Zhubei City (TW)

(72) Inventor: Chih Hung WANG, Zhubei City (TW)

(73) Assignee: Taiwan Happy Energy Co., Ltd., Zhubei City (TW)

(21) Appl. No.: 17/649,258

(22) Filed: Jan. 28, 2022

(51) Int. Cl. B64G 1/26; F02K 9/50; F02K 9/62; F02K 9/60

(52) U.S. Cl. CPC B64G 1/26; F02K 9/50; F02K 9/605; F02K 9/62

(57) ABSTRACT

A liquid-driven propulsion device includes a first and a second chamber. The first chamber includes a first seal movable or deformable within the first chamber, the first seal being configured to separate a working liquid in the first chamber from a first space having a first pressure. The second chamber includes a second seal movable or deformable within the second chamber and configured to separate a working liquid in the second chamber from a second space having a second pressure. The first and the second chambers are coupled to each other to enable a flow of liquid between the first and second chambers. When the first pressure is greater than the second pressure, the working liquid in the first chamber moves in a first direction and the working liquid in the second chamber moves in a second direction to provide a propulsion force applied to the liquid-driven propulsion device.

### TECHNICAL FIELD

The present disclosure relates to propulsion devices, and more particularly, to liquid-driven propulsion devices and propulsion systems for driving aircrafts or aerospace and other vehicles.

### BACKGROUND

Rocket driven propulsion systems are commonly used in spacecraft, satellite, and other aerospace applications. However, due to costs of rockets and other propulsion systems, there are needs for controllable, reliable, economical, and/or reusable launching and propulsion systems, such as those for spacecrafts, including sub-orbital or orbital spaceflights.

In some reusable spacecraft designs, landing can be accomplished with parachutes. In some other designs, landings can be accomplished by propulsive devices. For example, thruster rockets are used to provide a propulsion force to slow the spacecraft during the landing, and extendable arms may be used to balance, support, or angle the spacecraft upon touchdown. However, rocket propulsion systems can be complex, costly, and involve reliability and reusability concerns. In addition, the extreme heat caused by the thruster rockets may damage other parts of spacecrafts. Accordingly, there is a need to improve the propulsion systems for aerospace and space vehicles and other aircrafts for addressing or balancing reliability, cost, and/or safety concerns.

### SUMMARY

The present disclosure provides a liquid-driven propulsion device. Consistent with one of the embodiments, the liquid-driven propulsion device includes a first chamber and a second chamber. The first chamber includes a first seal movable or deformable within the first chamber, the first seal being configured to separate a working liquid in the first chamber from a first space within the first chamber. The first space has a first pressure. The second chamber includes a second seal movable or deformable within the second chamber and configured to separate a working liquid in the second chamber from a second space within the second chamber. The second space has a second pressure. The first chamber and the second chamber are coupled to each other to enable a flow of liquid between the first and second chambers. When the first pressure is greater than the second pressure, the working liquid in the first chamber moves in a first direction and the working liquid in the second chamber moves in a second direction to provide a propulsion force applied to the liquid-driven propulsion device.

Consistent with some other embodiments, the present disclosure provides a liquid-driven propulsion device including a liquid circulation loop and a booster pump device. The liquid circulation loop provides a flow passage configured to enable a flow of a working liquid. The flow passage is configured to provide different cross-sectional areas for a first portion and a second portion of the flow passage. The booster pump device is arranged in the liquid circulation loop and configured to compress the working liquid to move the working liquid in the flow passage. The working liquid in the first portion moves in a first direction and the working liquid in the second portion moves in a second direction to provide a propulsion force.

It is to be understood that the foregoing general descriptions and the following detailed descriptions are exemplary and explanatory only, and are not restrictive of the disclosure, as claimed.

### BRIEF DESCRIPTION OF THE DRAWINGS

The accompanying drawings, which are incorporated in and constitute a part of this specification, illustrate several embodiments and, together with the description, serve to explain the disclosed principles. In the drawings:

FIG. 1 is a diagram which illustrates an exemplary cylindrical chamber, consistent with some embodiments of the present disclosure.

FIG. 2 is a diagram which illustrates a device having two cylindrical chambers and coupled to each other, consistent with some embodiments of the present disclosure.

FIG. 3A is a diagram which illustrates an exemplary liquid-driven propulsion device modified based on the device of FIG. 2, consistent with some embodiments of the present disclosure.

FIG. 3B is a diagram which illustrates the liquid-driven propulsion device with a gas-driven mechanism, consistent with some embodiments of the present disclosure.

FIG. 4 is a diagram which illustrates another exemplary liquid-driven propulsion device, consistent with some embodiments of the present disclosure.

FIG. 5 is a diagram which illustrates another exemplary liquid-driven propulsion device, consistent with some embodiments of the present disclosure.

FIG. 6 is a diagram which illustrates another exemplary liquid-driven propulsion device, consistent with some embodiments of the present disclosure.

FIG. 7 is a diagram which illustrates another exemplary liquid-driven propulsion device, consistent with some embodiments of the present disclosure.

FIG. 8 is a diagram which illustrates another exemplary liquid-driven propulsion device, consistent with some embodiments of the present disclosure.

FIG. 9 is a diagram which illustrates another exemplary liquid-driven propulsion device, consistent with some embodiments of the present disclosure.

FIG. 10 is a diagram which illustrates another exemplary liquid-driven propulsion device, consistent with some embodiments of the present disclosure.

### DETAILED DESCRIPTION

Reference will now be made in detail to exemplary embodiments, examples of which are illustrated in the accompanying drawings and disclosed herein. Wherever convenient, the same reference numbers will be used throughout the drawings to refer to the same or like parts. The implementations set forth in the following description of exemplary embodiments are examples of devices and methods consistent with the aspects related to the disclosure as recited in the appended claims, and not meant to limit the scope of the present disclosure.

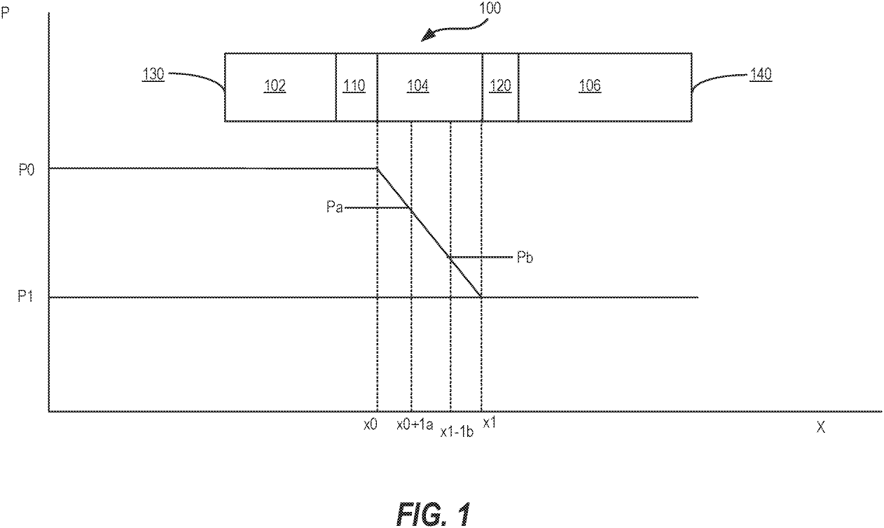

FIG. 1 is a diagram which illustrates an exemplary cylindrical chamber 100, consistent with some embodiments of the present disclosure. Although cylindrical chambers are used in describing various embodiments in this specification, chambers consistent with the present invention may be designed with various shapes, dimensions, aspect ratios, materials, rigidity, elasticity, etc. As shown in FIG. 1, the cylindrical chamber 100 is separated by a first seal 110 and a second seal 120 into three parts. A seal, such as the ones illustrated in FIG. 1, can be a member or surface that is movable within a space and may be driven to convert pressure to movement or output force. Depending on its application, material, and structure, a seal is also known as a piston, a valve, a piston valve, a diaphragm, or other names providing such function. While metals or alloys with some sealing elements made of rubber, silicon, or other elastic materials are common materials for a seal and other components described below, various materials, combinations, structures, and designs may be used, and they can vary depending on applications, operating conditions, operating environments, costs, and other considerations.

Referring to FIG. 1, a first space 102 between a first wall 130 of the cylindrical chamber 100 and the first seal 110 contains gas with an initial gas pressure P0. A second space 104 between the first seal 110 and the second seal 120 contains working liquid. A third space 106 between a second wall 140 of the cylindrical chamber 100 and the second seal 120 contains gas with an initial gas pressure P1. The first seal 110 and the second seal 120 function as gas-liquid isolators and are configured to isolate the gas and the liquid in the cylindrical chamber 100. In other words, the first seal 110 and the second seal 120 respectively prevent the gas within the space 102 and the gas within the space 106 from flowing into the space 104, and also prevent the liquid within the space 104 from flowing into the space 102 and the space 106. The first seal 110 and the second seal 120 are movable or deformable within the cylindrical chamber 100 to enlarge or reduce the space 102 and the space 106 in response to the difference between the gas pressure P0 and the gas pressure P1 of the spaces 102 and 106.

For example, in some embodiments, the seals 110, 120 may include a piston part and an elastic member (e.g., a balloon) containing liquid. An opening of the elastic member is along an x-axis, and a top portion of the elastic member is coupled to the piston part. Particularly, the opening of the elastic member in the seal 110 is along a positive x-axis, and the opening of the elastic member in the seal 120 is along a negative x-axis. When the gas pressure (e.g., P0 in the initial state) in the space 102 is greater than the gas pressure (e.g., P1 in the initial state) in the space 104, in response to the movement of the piston part of the seal 110 along the positive x-axis, the volume of the elastic member of the seal 110 decreases and the liquid inside the elastic member flows out from the opening. Accordingly, the liquid in the space 104 moves toward the positive x-axis, and flows into the elastic member of the seal 120 via the opening. As the volume of the elastic member of the seal 120 increases, the piston part of the seal 120 also moves along the positive x-axis and compresses the gas within the space 106. It is noted that, as used herein in the present disclosure, the x-axis direction may refer to any possible direction.

In the system shown in FIG. 1, assuming that the cylindrical chamber 100 is not fixed, at an initial state, a force F0 toward the negative x-axis due to the gas pressure in the space 102 is applied on the first wall 130, and a force F1 toward the positive x-axis due to the gas pressure in the space 106 is applied on the second wall 140. The total force applied on the cylindrical chamber 100 can be calculated using the following equations:

$$F = F 1 - F 2 = {\text{P}}_{0} ⋅ A - {\text{P}}_{1} ⋅ A = \left({\text{P}}_{0} - {\text{P}}_{1}\right) ⋅ A$$

, where F denotes the total force toward the negative x-axis, P₀ and P₁ respectively denote the initial pressure of the space 102 and the space 106, and A denotes the cross-sectional area of the cylindrical chamber 100.

At the same time, the same force due to the gas pressure is also applied on the seals 110, 120 and the liquid within the space 104 in the opposite direction. Accordingly, the cylindrical chamber 100 is accelerated toward the negative x-axis, while the seals 110, 120 and the liquid are accelerated toward the positive x-axis. Due to the movement, the volume of the space 102 increases and the volume of the space 106 decreases. As the gas pressure within the space 102 decreases and the gas pressure within the space 106 increases, the net force becomes zero when the cylindrical chamber 100 is positioned at an equilibrium position, in which the gas pressure within two spaces 102 and 106 is equal. Then the net force gradually increases toward the opposite direction as the cylindrical chamber 100 moving away from the equilibrium position, until the velocity of the cylindrical chamber 100 reduces to zero when the cylindrical chamber 100 reaches the other extreme position. Accordingly, the cylindrical chamber 100 oscillates along the x-axis periodically.

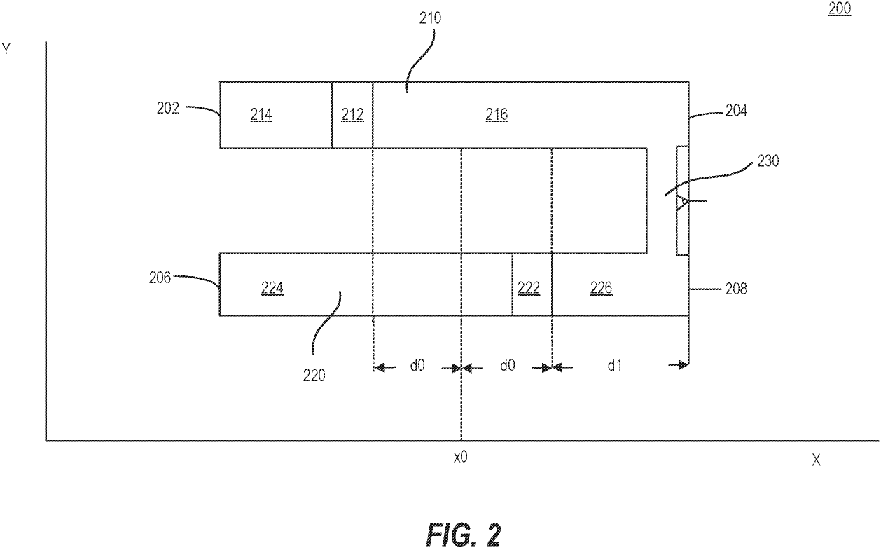

FIG. 2 is a diagram which illustrates a device 200 having two cylindrical chambers 210 and 220 coupled to each other, consistent with some embodiments of the present disclosure. In the device 200, two cylindrical chambers 210 and 220 are coupled via a connecting tube 230 filled with liquid. Similar to the cylindrical chamber 100 in FIG. 1, the cylindrical chamber 210 includes a first seal 212 movable or deformable within the cylindrical chamber 210 and configured to separate the working liquid in the space 216 and the gas within the space 214 of the cylindrical chamber 210. Similarly, the cylindrical chamber 220 also includes a second seal 222 movable or deformable within the cylindrical chamber 220 and configured to separate the working liquid in the space 226 and the gas within the space 224 of the cylindrical chamber 220. The connecting tube 230 communicates the working liquid within the cylindrical chambers 210 and 220.

As shown in FIG. 2, in an initial state, the seal 212 is located at a first initial position (e.g., x0-d0) along the x-axis which is offset from the equilibrium position x0, and the seal 222 is located at a second initial position (e.g., x0+d0) along the x-axis which is offset from the equilibrium position x0. Similar to the embodiment shown in FIG. 1, if the initial gas pressure P0 in the space 214 is greater than the initial gas pressure P1 in the space 224, in the first half cycle, the connecting tube 230 enables a flow of liquid from the cylindrical chamber 210 to the cylindrical chamber 220, with the movement of the seal 212 along the positive x-axis direction and the movement of the seal 222 along the negative x-axis direction. Accordingly, the volume of the space 214 increases and the volume of the space 224 decreases, until the seal 212 reaches its extreme position (e.g., x0+d0) along the x-axis, and the seal 222 reaches its extreme position (e.g., x0-d0) along the x-axis.

Then, in the second half cycle, the connecting tube 230 enables a flow of liquid back from the cylindrical chamber 220 to the cylindrical chamber 210, with the movement of the seal 212 along the negative x-axis direction and the movement of the seal 222 along the positive x-axis direction. Accordingly, the volume of the space 224 increases and the volume of the space 214 decreases, until the seals 212 and 222 reach their respective initial positions (e.g., x0-d0 and x0+d0) along the x-axis again to complete the cycle. Accordingly, the liquid within the spaces 216 and 226 and the connecting tube 230 flows periodically in response to the oscillation of the seals 212 and 222. In some embodiments, positions of the seals 212 and 222 along the x-axis can be expressed using the following functions:,

$$\text{x} 1 \left(t\right) = \text{x} 0 + \text{d} 0 ⋅ cos \left(ω t + π\right)$$

$$\text{x} 2 \left(t\right) = \text{x} 0 + \text{d} 0 ⋅ cos \left(ω t\right)$$

where x1(t) and x2(t) respectively denote the positions of the seals 212 and 222 along the x-axis at time t, and ω denotes the frequency.

Due to the gas pressure in the spaces 214 and 224, the total force toward the negative x-axis applied on the walls 202 and 206 can be expressed using the following function:,

$${\text{F}}_{S a} \left(t\right) = \left(\text{P} 0 \left(\text{t}\right) + \text{P} 1 \left(\text{t}\right)\right) ⋅ A$$

where P0(t), P1(t) respectively denote the function of the gas pressure within the spaces 214 and 224 at time t, and A denotes the cross-section area of the cylindrical chambers 210 and 220.

In addition, due to the liquid static pressure applied to the walls 204 and 208, a total force toward the positive x-axis is generated and applied to the device 200, which can be expressed using the following function:,

$$\begin{matrix}{\text{F}}_{S b} \left(t\right) = \left({\text{P}}_{\text{S} 1} \left(\text{t}\right) + {\text{P}}_{\text{S} 2} \left(\text{t}\right)\right) ⋅ A \\ = \left(\text{P} 0 \left(\text{t}\right) + \text{P} 1 \left(\text{t}\right)\right) ⋅ A - 2 ⋅ \text{ρ} ⋅ \text{d} 0 ⋅ cos \left(ω t\right) ⋅ a ⋅ A\end{matrix}$$

where P_{S1}(t), P_{S2}(t) respectively denote the function of the liquid static pressure applied to the walls 204 and 208 at time t, a denotes the liquid acceleration, and p denotes the liquid density. Particularly, P_{S1} (t), P_{S2} (t) can be calculated using the following equations:

$${\text{P}}_{\text{S} 1} \left(\text{t}\right) = \text{P} 0 \left(\text{t}\right) - \text{ρ} ⋅ \left[\left(\text{x} 0 + \text{d} 0 + \text{d} 1\right) - \text{x} 1 \left(t\right)\right] ⋅ a$$

$${\text{P}}_{\text{S} 2} \left(\text{t}\right) = \text{P} 1 \left(\text{t}\right) + \text{ρ} ⋅ \left[\left(\text{x} 0 + \text{d} 0 + \text{d} 1\right) - \text{x} 2 \left(t\right)\right] ⋅ a$$

Based on the equations above, the sum of the force due to the liquid static pressure and the gas pressure applied to the device 200 can be expressed using the following function:,

$$\begin{matrix}{F}_{s} \left(t\right) = {F}_{S a} \left(t\right) - {F}_{S b} \left(t\right) = \\ 2 \text{ρ} ⋅ \text{d} 0 ⋅ cos \left(ω t\right) ⋅ a ⋅ A = 2 \text{ρ} ⋅ \text{d} {0}^{2} ⋅ {ω}^{2} ⋅ {cos}^{2} \left(ω t\right) ⋅ A\end{matrix}$$

where the liquid acceleration a can be expressed as:

$$a = \text{d} 0 ⋅ {ω}^{2} ⋅ cos \left(ω t\right)$$

In addition, during the first half cycle, when the liquid in the space 216 flows toward the positive x-axis direction, a dynamic force toward the positive x-axis applied to the wall 204 can be expressed using the following function:,

$${\text{F}}_{d 1} \left(t\right) = \left(\text{ρ} ⋅ {\text{v}}_{1} ⋅ Δ \text{t} ⋅ A\right) ⋅ \frac{{\text{v}}_{1}}{Δ \text{t}} = \text{ρ} ⋅ {\text{v}}_{1} {}^{2} ⋅ A$$

where v₁ denotes the velocity of the liquid. The liquid in the space 226 flows, with the same velocity and toward the opposite direction (e.g., the negative x-axis direction). Accordingly, another dynamic force toward the positive x-axis applied to the wall 208 can be expressed using the following function:

$${\text{F}}_{d 2} \left(t\right) = \text{ρ} ⋅ {\text{v}}_{1} {}^{2} ⋅ A$$

Based on the equations above, the sum of the dynamic force due to the liquid flowing from the cylindrical chamber 210 to the cylindrical chamber 220 can be expressed using the following function:

$$\begin{matrix}{\text{F}}_{d} \left(t\right) = {\text{F}}_{d 1} \left(t\right) + {\text{F}}_{\text{d} 2} \left(t\right) = \\ 2 \text{ρ} ⋅ {\text{v}}_{1} {}^{2} ⋅ A = 2 \text{ρ} ⋅ \text{d} {0}^{2} ⋅ {ω}^{2} ⋅ {sin}^{2} \left(ω t\right) ⋅ A\end{matrix}$$

The force F_{d}(t) toward the positive x-axis direction and the force Fₛ(t) toward the negative x-axis direction applied on the device 200 have the same amplitude but with a phase angle shift of 90 degrees. Accordingly, the device 200 may oscillate along the x-axis periodically.

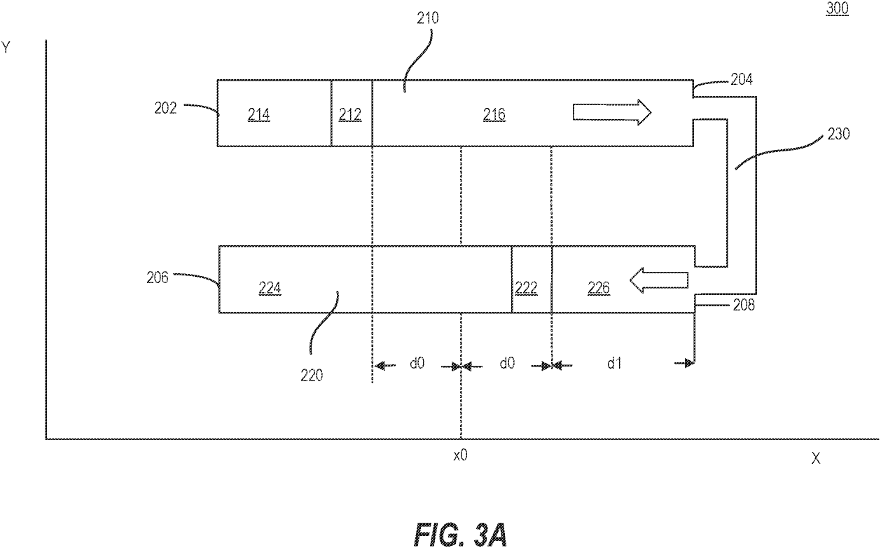

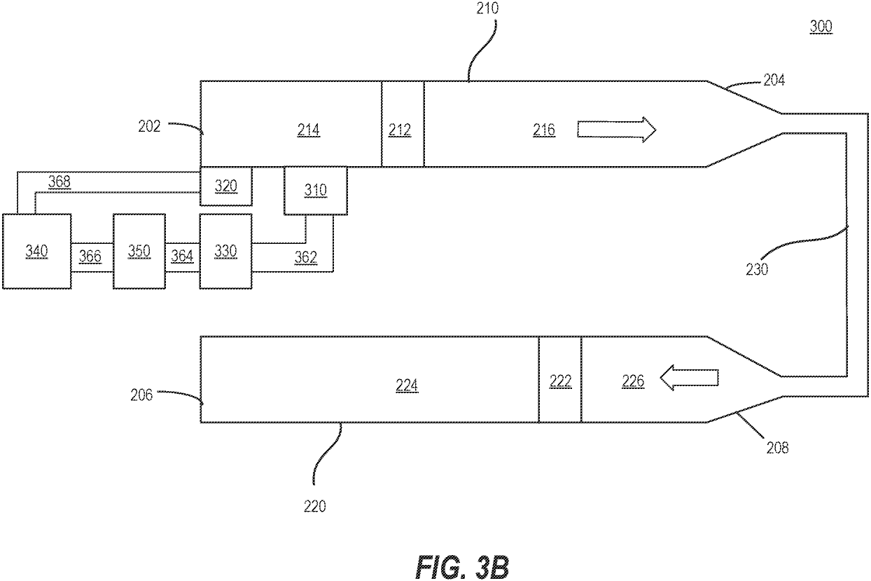

FIG. 3A is a diagram which illustrates an exemplary liquid-driven propulsion device 300 modified based on the device 200 of FIG. 2, consistent with some embodiments of the present disclosure. Compared to the device 200 in FIG. 2, in the liquid-driven propulsion device 300, the connecting tube 230 has a u-shape and is configured to enable the working liquid to move in different directions within the connecting tube 230 during a first period (e.g., the first half cycle) and a second period (e.g., the second half cycle). Accordingly, in the embodiments of FIG. 3A, the working liquid changes its moving direction within the connecting tube 230, and not within the cylindrical chambers 210 and 220. In some embodiments, cylindrical chambers 210 and 220 both have a cylindrical shape and have approximately the same cross-sectional area, but the present disclosure is not limited thereto. In other embodiments, the cylindrical chambers 210 and 220 may have different shapes or different cross-sectional areas.

As shown in FIG. 3A, the cross-sectional area of the connecting tube 230 is smaller than the cross-sectional area of the cylindrical chambers 210 and 220. For example, the cross-sectional area of the connecting tube 230 may be A/k, in which k is greater than 1. According to the equation of continuity, the liquid velocity within the connecting tube 230 can be expressed using the following function:

$${\text{v}}_{2} = k ⋅ {\text{v}}_{1}$$

Therefore, during the first half cycle, when the liquid in the upper half of the connecting tube 230 flows toward the positive x-axis direction, the dynamic force toward the positive x-axis applied to the wall of the connecting tube 230 can be further expressed using the following function:

$${{\text{F}}^{′}}_{d 1} = \text{ρ} ⋅ {\text{v}}_{2} {}^{2} ⋅ A / k = k ⋅ \text{ρ} ⋅ {\text{v}}_{1} {}^{2} ⋅ A$$

Similarly, the liquid in the lower half of the connecting tube 230 flows, with the same velocity and toward the opposite direction (e.g., the negative x-axis direction). Accordingly, another dynamic force toward the positive x-axis applied to the wall of the connecting tube 230 can be further expressed using the following function:

$${{\text{F}}^{′}}_{d 2} = \text{ρ} ⋅ {\text{v}}_{2} {}^{2} ⋅ A / k = k ⋅ \text{ρ} ⋅ {\text{v}}_{1} {}^{2} ⋅ A$$

Based on the equations above, the sum of the dynamic force due to the liquid flowing from the cylindrical chamber 210 to the cylindrical chamber 220 can be expressed using the following function:

$$\begin{matrix}{{\text{F}}^{′}}_{d} \left(t\right) = {{\text{F}}^{′}}_{d 1} \left(t\right) + {{\text{F}}^{′}}_{d 2} \left(t\right) = \\ k ⋅ \left(2 \text{ρ} ⋅ {\text{v}}_{1} {}^{2} ⋅ A\right) = k ⋅ \left(2 \text{ρ} ⋅ \text{d} {0}^{2} ⋅ {ω}^{2} ⋅ {sin}^{2} \left(ω t\right) ⋅ A\right)\end{matrix}$$

In addition to the phase angle shift of 90 degrees, the amplitude of the force F’_{d}(t) toward the positive x-axis direction is k times of the amplitude of the force Fₛ(t) toward the negative x-axis direction applied on the liquid-driven propulsion device 300. Accordingly, in a complete cycle, a net force toward the positive x-axis direction is applied to the liquid-driven propulsion device 300 and provides an acceleration to the liquid-driven propulsion device 300 toward the positive x-axis direction. If the liquid-driven propulsion device 300 is still or moving toward the positive x-axis direction, the velocity of the liquid-driven propulsion device 300 increases. In other words, the liquid-driven propulsion device 300 operates in an acceleration phase. During the acceleration phase, the liquid velocity within the liquid-driven propulsion device 300 reduces, as the kinetic energy of the working liquid is converted into the kinetic energy of the liquid-driven propulsion device 300.

On the other hand, if the liquid-driven propulsion device 300 is moving toward the negative x-axis direction, the velocity of the liquid-driven propulsion device 300 decreases. In other words, the liquid-driven propulsion device 300 operates in a deceleration phase. During the deceleration phase, the liquid velocity within the liquid-driven propulsion device 300 increases, as the kinetic energy of the liquid-driven propulsion device 300 is converted into the kinetic energy of the working liquid.

The liquid-driven propulsion device 300 can be used in various applications. For example, the liquid-driven propulsion device 300 may be used in propulsion systems for aircraft, unmanned aerial vehicles (UAV), commonly known as a drone, or in various aerospace propulsion systems for aerospace vehicles. Particularly, the liquid-driven propulsion device 300 can also operate in zero gravity condition and applied in spacecraft or spaceship propulsion systems.

FIG. 3B is a diagram which illustrates the liquid-driven propulsion device 300 with a gas-driven mechanism to adjust the gas pressure within the space 214, consistent with some embodiments of the present disclosure. The gas-driven mechanism is configured to control the pressure within the space 214 and continuously provides high-pressure gas to the liquid-driven propulsion device 300 to drive the liquid-driven propulsion device 300. As shown in FIG. 3B, the gas-driven mechanism includes control valves 310 and 320 coupled with the cylindrical chamber 210, a low-pressure gas chamber 330 configured to store low-pressure gas, a high-pressure gas chamber 340 configured to store high-pressure gas, and an air compression device 350 coupled between the high-pressure gas chamber 340 and the low-pressure gas chamber 330. In the embodiments of FIG. 3B, channels 362, 364, 366, and 368 are arranged for coupling the control valves 310 and 320, the gas chambers 330 and 340, and the air compression device 350 to achieve the gas circulating system. In some embodiments, the air compression device 350 may be achieved by an air compressor, but the present disclosure is not limited thereto.

Particularly, in the first period, the control valve 320 opens so that the high-pressure gas in the high-pressure gas chamber 340 flows into the space 214 via the channel 368. After the control valve 320 closes, the volume of the space 214 continues to expand until the seal 212 reaches the maximum offset position. Particularly, the seal 212 moves in a first direction (e.g., the positive x-axis direction) within the cylindrical chamber 210, and the seal 222 moves in a second direction (e.g., the negative x-axis direction) that is approximately opposite to the first direction within the cylindrical chamber 220.

Next, in the second period, as the volume of the space 214 starts to reduce and the gas in the space 214 starts to compress, the control valve 310 opens so that the gas flows from the space 214 into the low-pressure gas chamber 330 via the channel 362. After the control valve 310 closes, the volume of the space 214 continues to reduce until the seal 212 reaches the initial offset position to complete one cycle. Particularly, the seal 212 moves in the second direction (e.g., the negative x-axis direction) within the cylindrical chamber 210, and the seal 222 moves in the first direction (e.g., the positive x-axis direction) within the cylindrical chamber 220.

In this operating cycle, the recycled gas stored in the low-pressure gas chamber 330 is provided to the air compression device 350 via the channel 364. Accordingly, the air compression device 350 is configured to compress the gas from the low-pressure gas chamber 330, and to provide the compressed gas to the high-pressure gas chamber 340 via the channel 366 to store the compressed gas for the first period in the next operating cycle. Accordingly, the control valve 320 coupled with the cylindrical chamber 210 can be configured to control the gas flow from the gas chamber 340 into the space 214 to increase the pressure in the space 214 in the first period of the operating cycle. The control valve 310 coupled with the cylindrical chamber 210 can be configured to control the gas flow from the space 214 into the gas chamber 330 in the second period of the operating cycle.

In some embodiments, the gas-driven mechanism may further include an additional control valve 370 coupled with the cylindrical chamber 210. The control valve 370 is configured to enable the gas flow between the liquid-driven propulsion device 300 with a surrounding atmosphere, to adjust the pressure within the space 214. In other words, in some embodiments, when the aerospace vehicle is within the atmosphere, the air compression device 350 can compress the air from the atmosphere directly and provide the compressed air to the high-pressure gas chamber 340 via the channel 366 to store the compressed air for the first period in the next operating cycle. The control valve 370 can be configured to discharge the gas from the space 214 into the atmosphere directly in the second period of the operating cycle.

In some embodiments, the liquid-driven propulsion device 300 may also include a heating device configured to heat the gas within the chamber 340 to generate the compressed gas to provide the gas flowing into the first cylinder 214 via the control valve 320 and the channel 368. For example, in some embodiments, liquefied gas, which is the gas turned into a liquid by cooling or compressing, may be stored in the chamber 340. By feeding the fuel gas into the fuel cell, the heating device is configured to heat the liquefied gas in the chamber 340 to generate the high-pressure gas, and then produce the high-pressure gas into the first cylinder 214 accordingly.

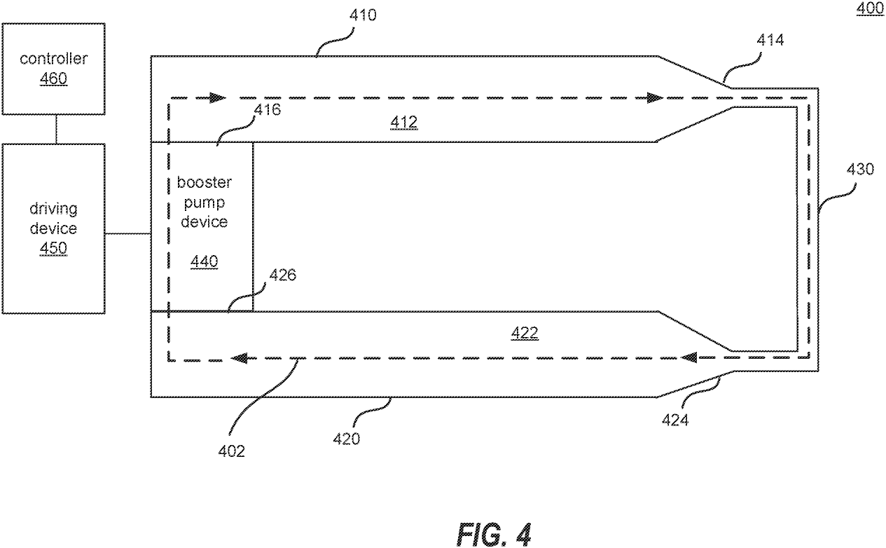

FIG. 4 is a diagram which illustrates another exemplary liquid-driven propulsion device 400, consistent with some embodiments of the present disclosure. Compared to the liquid-driven propulsion device 300 in FIGS. 3A and 3B, the liquid-driven propulsion device 400 includes a liquid circulation loop providing a flow passage configured to enable a flow 402 of a working liquid. As shown in FIG. 4, the flow passage is configured to provide different cross-sectional areas for a first portion and a second portion of the flow passage. For example, in some embodiments, the liquid-driven propulsion device 400 includes cylindrical chambers 410 and 420 fully filled with the working liquid 412 and 422, a connecting tube 430, and a booster pump device 440 forming the liquid circulation loop. Similar to the embodiments of FIGS. 3A and 3B, the cylindrical chambers 410 and 420 may also have a cylindrical shape and have approximately the same cross-sectional area, but the present disclosure is not limited thereto. In some other embodiments, the cylindrical chambers 410 and 420 may have different shapes or cross-sectional areas.

The connecting tube 430 is coupled between a first terminal 414 of the cylindrical chamber 410 and a first terminal 424 of the cylindrical chamber 420. As shown in FIG. 4, the connecting tube 430 is configured to enable a flow of liquid between the cylindrical chambers 410 and 420. In some embodiments, the cross-sectional area of the connecting tube 430 is smaller than the cross-sectional area of the cylinder chambers 410 and 420. Similar to the embodiments of FIGS. 3A and 3B, the cross-sectional area of the cylinder chambers 410 and 420 may be A, and the cross-sectional area of the connecting tube 430 may be A/k, in which k is greater than 1. In addition, the connecting tube 430 also has a u-shape to enable the working liquid to move in different directions within the connecting tube 430 during different periods, and to turn 180 degrees within the connecting tube 430.

According to the equation of continuity, the liquid velocity within the connecting tube 430 can be expressed using the following function:,

$${\text{v}}_{2} = k ⋅ {\text{v}}_{1}$$

where v₁ denotes the liquid velocity within the cylinder chambers 410 and 420, and v₂ denotes the liquid velocity within the connecting tube 430.

The booster pump device 440 arranged in the liquid circulation loop is coupled between a second terminal 416 of the cylinder chamber 410 and a second terminal 426 of the cylinder chamber 420. As shown in FIG. 4, the booster pump device 440 is configured to compress the working liquid to move the working liquid in the flow passage. In some embodiments, the working liquid in the first portion moves in a first direction and the working liquid in the second portion moves in a second direction to provide a propulsion force. Particularly, in the embodiments of FIG. 4, the booster pump device 440 compresses the working liquid 422 from the cylinder chamber 420, to move the working liquid from the cylinder chamber 410, via the connecting tube 430, to the cylinder chamber 420. By the booster pump device 440, the working liquid 412 in the cylinder chamber 410 continuously moves in a first direction (e.g., the positive x-axis direction), and the working liquid 422 in the cylinder chamber 420 moves in a second direction (e.g., the negative x-axis direction) approximately opposite to the first direction. Accordingly, the liquid movement in the liquid-driven propulsion device 400 provides a propulsion force approximately in the first direction.

During the operations, the forces due to the liquid static pressure applied to walls of the liquid-driven propulsion device 400 are balanced. When the working liquid turns its direction within the connecting tube 430 having a u-shape, the liquid flows in the connecting tube 430 provides a dynamic force toward the positive x-axis applied to the wall of the connecting tube 430, which can be expressed using the following function:

$${\text{F}}_{R} = 2 ⋅ \text{ρ} ⋅ {\text{v}}_{2} {}^{2} ⋅ A / k = k ⋅ \left(2 \text{ρ} ⋅ {\text{v}}_{1} {}^{2} ⋅ A\right)$$

Also, when the working liquid turns its direction at the walls of the cylinder chambers 410 and 420, the liquid also provides a dynamic force toward the negative x-axis applied to the walls of the cylinder chambers 410 and 420, which can be expressed using the following function:

$${\text{F}}_{L} = 2 \text{ρ} ⋅ {\text{v}}_{1} {}^{2} ⋅ A$$

Based on the equations above, the net force due to the liquid movement within the liquid-driven propulsion device 400 is toward the positive x-axis and can be expressed using the following function:

$${\text{F}}_{n} = {\text{F}}_{R} - {\text{F}}_{L} = \left(k - 1\right) ⋅ \left(2 \text{ρ} ⋅ {\text{v}}_{1} {}^{2} ⋅ A\right)$$

In some embodiments, the liquid-driven propulsion device 400 includes a driving device 450 coupled to the booster pump device 440 and a controller 460 coupled to the driving device 450 to control the driving device 450. The driving device 450 may provide energy to drive the booster pump device 440. For example, the driving device 450 may include a motor, a gas turbine engine, or a heat engine. The controller 460 is configured to adjust an input power of the booster pump device 440 by providing corresponding control signals to the driving device 450. For example, the average input power P_{w} of the booster pump device 440 in a time period Δt can be expressed using the following function:,

$${\text{P}}_{w} F ⋅ \frac{S}{Δ t}$$

where F denotes the applied force due to pressure and velocity difference between the liquid within the connecting tube 430 and the liquid within cylinder chambers 410 and 420 as a result of changes in flow direction and the cross-section area, and S denotes the distance of the liquid moving within the connecting tube 430 in the time period Δt. Particularly, assuming that the value of k is large enough, the applied force F and the distance S can be respectively expressed using the following functions:

$$F \approx \left({\text{P}}_{0} - {\text{P}}_{1}\right) ⋅ A / k$$

$$S = {\text{v}}_{2} ⋅ Δ t$$

Based on the equations above, the average input power P_{w} can be derived accordingly and further expressed using the following function:

$${\text{P}}_{w} = F ⋅ \frac{S}{Δ t} \approx \left({\text{P}}_{0} - {\text{P}}_{1}\right) ⋅ A / k ⋅ {\text{v}}_{2} = \left({\text{P}}_{0} - {\text{P}}_{1}\right) ⋅ A ⋅ {\text{v}}_{1}$$

When the above input power P_{w} of the booster pump device 440 is greater than the output power of the liquid-driven propulsion device 400, the extra inputted power can be used to increase the speed of the working liquid within the liquid-driven propulsion device 400, and increase the net force toward the positive x-axis accordingly. On the other hand, when the input power P_{w} of the booster pump device 440 is less than the output power of the liquid-driven propulsion device 400, the kinetic energy stored in the working liquid is used to compensate the power. The speed of the working liquid within the liquid-driven propulsion device 400 is decreased, and the net force toward the positive x-axis also decreases correspondingly.

By adjusting the electrical or mechanical power provided from the driving device 450 to the booster pump device 440, the controller 460 can control the operation of the liquid-driven propulsion device 400 properly to accelerate, decelerate, or maintain the speed of the liquid-driven propulsion device 400 at a steady value.

In some embodiments, the driving device may be a motor for driving the booster pump device 440. During the deceleration phase, the controller 460 may control the motor to operate as a generator to convert a portion of the kinetic energy stored in the working liquid into electricity, and store the generated electricity in a power storage device (e.g., a battery) coupled to the motor. In some other embodiments, the driving device may be a gas turbine engine for driving the booster pump device 440. Similarly, during the deceleration phase, the controller 460 may control the gas turbine engine to act as the gas compression device and compress the low-pressure gas into the high-pressure gas using the kinetic energy stored in the working liquid to store the energy for later use as well.

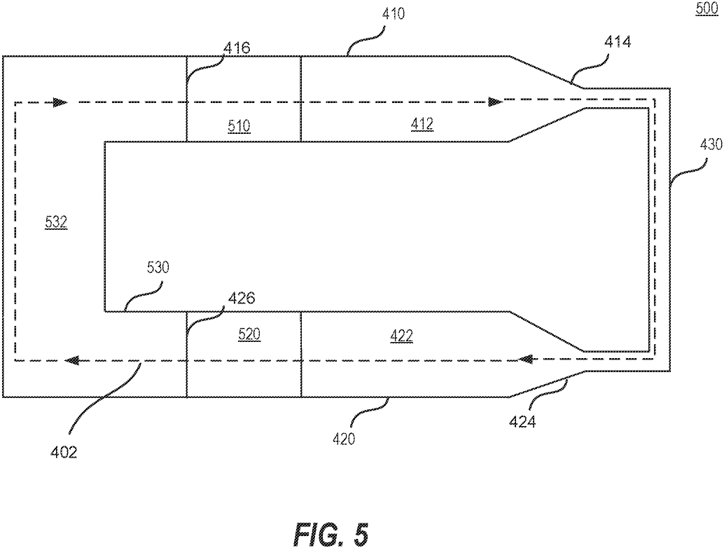

FIG. 5 is a diagram which illustrates another exemplary liquid-driven propulsion device 500, consistent with some embodiments of the present disclosure. Compared to the liquid-driven propulsion device 400 in FIG. 4, the liquid-driven propulsion device 500 may include two pump devices 510 and 520 to achieve the booster pump device. As shown in FIG. 5, the first pump device 510 is arranged and located within the cylinder chamber 410 and the second pump device 520 is arranged and located within the other cylinder chamber 420. In addition, another connecting tube 530 filled with the working liquid 532 is coupled between a second terminal 416 of the cylinder chamber 410 and a second terminal 426 of the cylinder chamber 420. In some embodiments, the cylinder chambers 410 and 420 and the connecting tube 530 have approximately the same cross-sectional area.

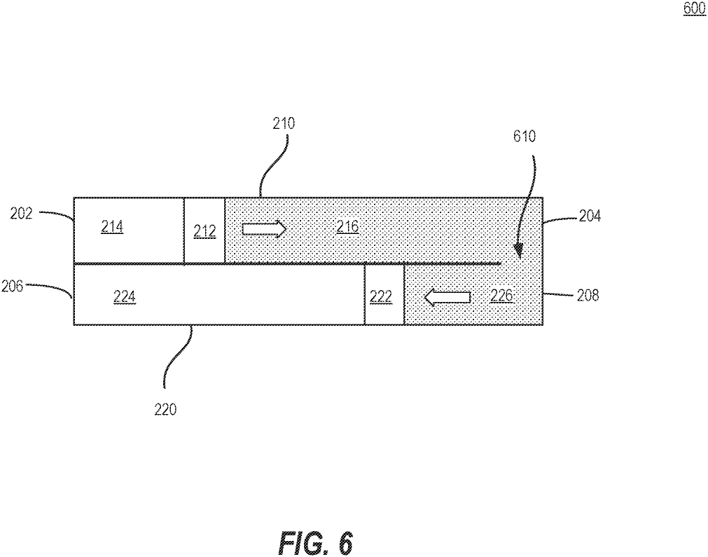

Various modifications and variations can be made to the liquid-driven propulsion devices 300, 400 and 500 disclosed in the embodiments of FIGS. 3A, 3B, 4, and 5. FIG. 6 is a diagram which illustrates another exemplary liquid-driven propulsion device 600, consistent with some embodiments of the present disclosure. Compared to the embodiments of FIGS. 3A and 3B, in the liquid-driven propulsion device 600 in FIG. 6, two chambers 210 and 220 are directly coupled to each other without a connecting tube. The working liquid in the space 216 and in the space 226 can flow through an opening 610 between two chambers 210 and 220. The opening 610 may have a cross-sectional area smaller than the cross-sectional area of the cylinder chambers 210 and 220.

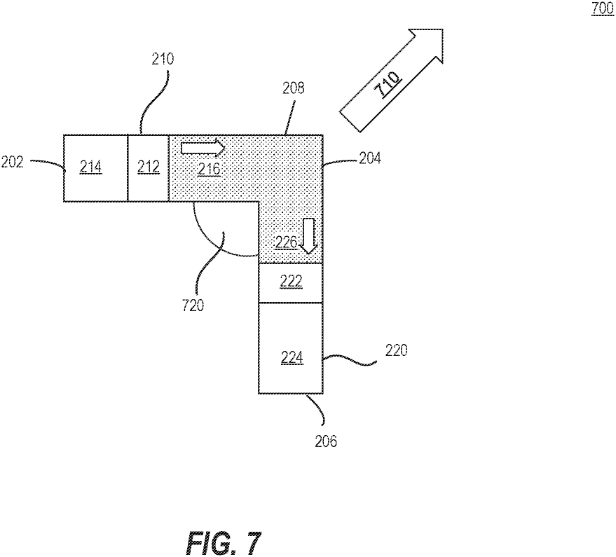

In the embodiments of FIGS. 3A and 3B, the working liquid in the space 216 and in the space 226 flows toward parallel and opposite directions, but the present disclosure is not limited thereto. FIG. 7 is a diagram which illustrates another exemplary liquid-driven propulsion device 700, consistent with some embodiments of the present disclosure. Compared to the embodiments of FIGS. 3A and 3B, in the liquid-driven propulsion device 700 in FIG. 7, two chambers 210 and 220 are arranged nonparallel to each other. Accordingly, the working liquid in the chamber 210 may flow toward the positive or negative x-axis direction, while the working liquid in the chamber 220 may flow toward the positive or negative y-axis direction to provide a propulsion force 710 having both a horizontal component (e.g., parallel to the x-axis) and a vertical component (e.g., parallel to the y-axis). It would be appreciated that while the axial directions of two chambers 210 and 220 are orthogonal to each other in FIG. 7, in some other embodiments, the angle 720 between axial directions of two chambers 210 and 220 can be any value.

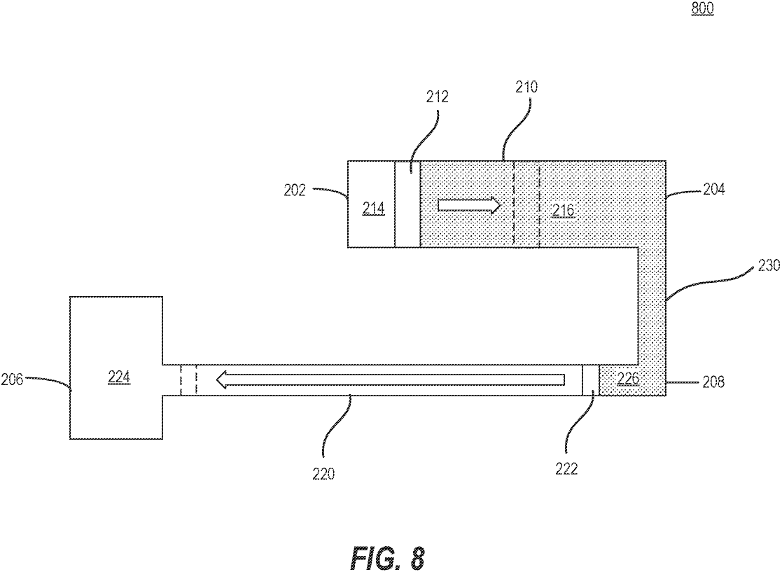

FIG. 8 is a diagram which illustrates another exemplary liquid-driven propulsion device 800, consistent with some embodiments of the present disclosure. In the embodiments of FIG. 8, the cylinder chambers 210 and 220 have different shapes and different cross-sectional areas. For example, the cross-sectional area of the cylinder chamber 210 may be greater than the cross-sectional area of the cylinder chamber 220. Accordingly, the offset distances for the seals 212 and 222 may also be different during the operation. In some embodiments, the difference among the cross-sectional areas of the cylinder chambers 210, 220 and the connecting tube 230 may impact the resultant propulsion force.

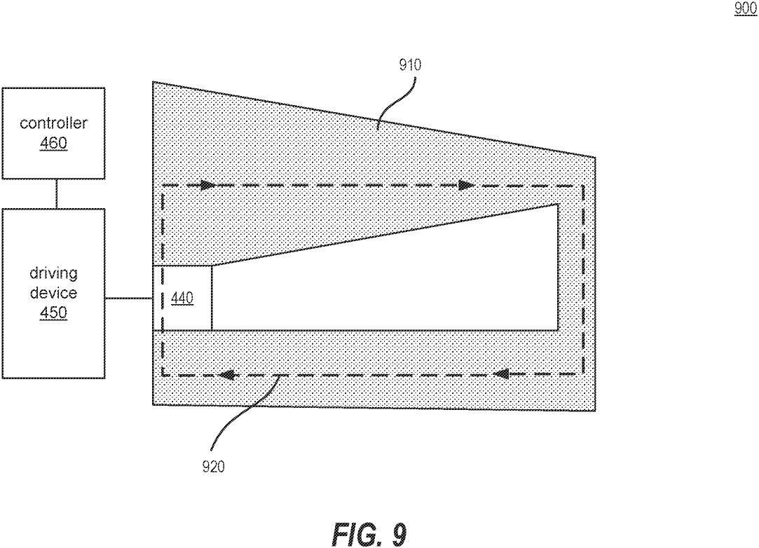

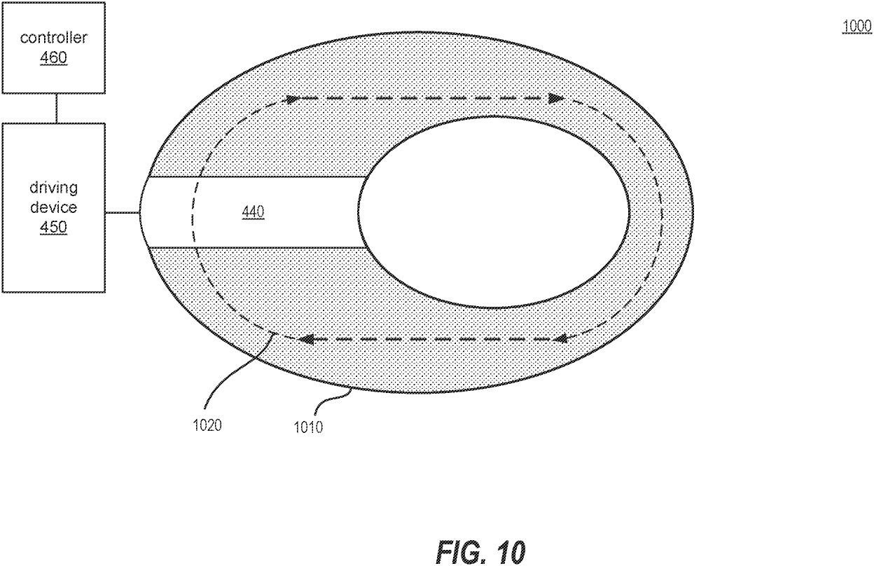

FIGS. 9 and 10 are two diagrams which respectively illustrate exemplary liquid-driven propulsion devices 900 and 1000, consistent with some embodiments of the present disclosure. As shown in FIGS. 9 and 10, the liquid circulation loops 910 and 1010 may be achieved by various structures or shapes providing different portions having different cross-sectional areas to provide the propulsion force, with the booster pump device 440 enabling the flow 920, 1020 of the working liquid in the flow passages provided by the liquid circulation loops 910 and 1010. It would be appreciated that other designs are possible, and the liquid-driven propulsion devices 900 and 1000 illustrated in FIGS. 9 and 10 are merely examples and not meant to limit the present disclosure.

For the liquid-driven propulsion devices 300-1000 disclosed in the embodiments of FIGS. 3A, 3B, and 4-10, the size of the liquid-driven propulsion devices 300-1000 may vary based on the switching speed of the control valve and the diameter of the control valve. For example, the size of the chambers can be determined according to the diameter of the control valve. A control valve with a relatively large diameter may have a lower switching speed, which reduces the operating frequency of the liquid-driven propulsion devices 300-1000. In some embodiments, the size of the liquid-driven propulsion devices 300-1000 may also vary based on the friction force within the connecting tubes, which is proportional to the speed of the working liquid and inversely proportional to the diameter of the connecting tubes.

In addition, the ranges of operating pressures within liquid-driven propulsion devices 300-1000 may vary based on the control valve, its operation, and/or operating conditions. The control valves applied in high pressure difference applications may have a relatively high complexity and with a relatively slow switching capability and/or reliability. In various embodiments, liquids with high density, low viscosity, and high boiling point may be selected as the working liquid for liquid-driven propulsion devices 300-1000. For example, the working liquid may be water, oil, or other liquids with a wide range of viscosity, operating range, and stability.

In view of the above, the liquid-driven propulsion devices 300-1000 disclosed in the embodiments of FIGS. 3A, 3B, and 4-10 can be adopted in various applications, including major or supplemental propulsion systems for UAVs, airplanes, helicopters, spaceships, hover cars, etc. In some embodiments, the liquid-driven propulsion devices 300-1000 can be driven by electricity without exhausting gas and with low noise. Also, the liquid-driven propulsion devices 300-1000 disclosed in various embodiments of the present disclosure are suitable for spaceship applications. Specifically, before the generated propulsion force overcomes the weight of the spaceship, the inputted power is not wasted because the power is converted into the kinetic energy of the working liquid to increase the propulsion force. As the propulsion force applied to the spaceship increases, the spaceship eventually overcomes the gravity and takes off, in response to the power provided from the driving device.

In addition, during the deceleration phase, such as the landing of the spaceship, the extra power generated can be converted into the electricity or other energy form to be re-used in the next launching or acceleration process, which saves the required power source and reduces the energy wastes. Accordingly, the maximum total range of the spaceship or aircraft can be improved. Furthermore, the liquid-driven propulsion device can be used to control the landing of reusable spacecrafts with lower heat waste and without the engine ignition required in traditional propulsive landing operations. Particularly, during the landing process, the gravitational energy of the spaceship can be converted into electricity or other energy forms, which can be stored or consumed properly. Accordingly, the spaceship can achieve a safe and reliable landing.

In the foregoing specification, embodiments have been described with reference to numerous specific details that can vary from implementation to implementation. Certain adaptations and modifications of the described embodiments can be made. It is also intended that the sequence of steps shown in figures are only for illustrative purposes and are not intended to be limited to any particular sequence of steps. As such, those skilled in the art can appreciate that these steps can be performed in a different order while implementing the same method.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

In the drawings and specification, there have been disclosed exemplary embodiments. It will be apparent to those skilled in the art that various modifications and variations can be made to the disclosed system and related methods. Other embodiments will be apparent to those skilled in the art from consideration of the specification and practice of the disclosed system and related methods. It is intended that the specification and examples be considered as exemplary only, with a true scope being indicated by the following claims and their equivalents.

What is claimed is:

1. A liquid-driven propulsion device comprising:
a first chamber including a first seal movable or deformable within the first chamber, the first seal being configured to separate a working liquid in the first chamber from a first space within the first chamber, the first space having a first pressure; and
a second chamber comprising a second seal movable or deformable within the second chamber and configured to separate a working liquid in the second chamber from a second space within the second chamber, the second space having a second pressure, wherein the first chamber and the second chamber are coupled to each other to enable a flow of liquid between the first and second chambers;
wherein when the first pressure is greater than the second pressure, the working liquid in the first chamber moves in a first direction and the working liquid in the second chamber moves in a second direction to provide a propulsion force applied to the liquid-driven propulsion device.

2. The liquid-driven propulsion device of claim 1, wherein the second direction is approximately opposite to the first direction, and the propulsion force is approximately in the first direction.

3. The liquid-driven propulsion device of claim 1, further comprising:
a connecting tube coupled between the first and second chambers, the connecting tube configured to enable the flow of liquid between the first and second chambers.

4. The liquid-driven propulsion device of claim 3, wherein a cross-sectional area of the connecting tube is smaller than the cross-sectional area of the first and second chambers.

5. The liquid-driven propulsion device of claim 4, wherein the connecting tube has a u-shape and is configured to enable the working liquid to move in different directions within the connecting tube during a first period and a second period.

6. The liquid-driven propulsion device of claim 1, wherein the first chamber and the second chamber both have a cylindrical shape and have approximately the same cross-sectional area.

7. The liquid-driven propulsion device of claim 1, further comprising:
a first control valve coupled with the first chamber and configured to control a gas flow from a high-pressure gas chamber into the first space to increase the first pressure in a first period of an operating cycle; and
a second control valve coupled with the first chamber and configured to control a gas flow from the first space into a low-pressure gas chamber in a second period of the operating cycle.

8. The liquid-driven propulsion device of claim 7, further comprising:
an air compression device coupled between the high-pressure gas chamber and the low-pressure gas chamber, the air compression device configured to compress a gas within the low-pressure gas chamber and store a compressed gas in the high-pressure gas chamber.

9. The liquid-driven propulsion device of claim 7, further comprising:
a third control valve coupled with the first chamber and configured to enable a gas flow between the liquid-driven propulsion device with a surrounding atmosphere to adjust the first pressure within the first space.

10. The liquid-driven propulsion device of claim 7, further comprising:
a heating device configured to heat a gas within the high-pressure gas chamber to provide the gas flowing into the first chamber via the first control valve.

11. A liquid-driven propulsion device, comprising:
a liquid circulation loop providing a flow passage configured to enable a flow of a working liquid, wherein the flow passage is configured to provide different cross-sectional areas for a first portion and a second portion of the flow passage; and
a booster pump device arranged in the liquid circulation loop and configured to compress the working liquid to move the working liquid in the flow passage, wherein the working liquid in the first portion moves in a first direction and the working liquid in the second portion moves in a second direction to provide a propulsion force.

12. The liquid-driven propulsion device of claim 11, wherein the liquid circulation loop comprises:
a first chamber including the working liquid;
a second chamber including the working liquid, wherein the first chamber and the second chamber both have a cylindrical shape and have approximately the same cross-sectional area; and
a connecting tube coupled between a first terminal of the first chamber and a first terminal of the second chamber, the connecting tube configured to enable the flow of the working liquid between the first and second chambers, wherein the cross-sectional area of the connecting tube is smaller than the cross-sectional area of the first and second chambers;
wherein the second direction is approximately opposite to the first direction to provide the propulsion force approximately in the first direction.

13. The liquid-driven propulsion device of claim 12, further comprising:
a second connecting tube coupled between a second terminal of the first chamber and a second terminal of the second chamber, wherein the first chamber, the second chamber, and the second connecting tube have approximately the same cross-sectional area.

14. The liquid-driven propulsion device of claim 11, further comprising:
a driving device coupled to the booster pump device and configured to provide energy to drive the booster pump device.

15. The liquid-driven propulsion device of claim 14, wherein the driving device comprises a motor, a gas turbine engine, or a heat engine.

16. The liquid-driven propulsion device of claim 14, further comprising:
a controller coupled to the driving device and configured to adjust an input power of the booster pump device.

17. The liquid-driven propulsion device of claim 11, further comprising:
a motor coupled to the booster pump device and configured to drive the booster pump device; and
a power storage device coupled to the motor.

18. The liquid-driven propulsion device of claim 17, further comprising:
a controller configured to control the motor to operate as a generator to convert a portion of kinetic energy of the working liquid to electricity stored in the power storage device.

19. The liquid-driven propulsion device of claim 11, wherein the booster pump device comprises a first pump device located within the first portion and a second pump device located within the second portion.

20. The liquid-driven propulsion device of claim 11, wherein the liquid circulation loop is configured to enable the working liquid to move in different directions within the flow passage during a first period and a second period.
